(19) United States
(12) Patent Application Publication
(10) Pub. No.: US 2002/0118934 A1
(43) Pub. Date: Aug. 29, 2002

(54) Method and system for dispersion management with Raman amplification

(76) Inventors: Yochay Danziger, Dallas, TX (US); Yongqian Liu, Richardson, TX (US)

Correspondence Address: LASERCOMM, INC., INTELLECTUAL PROPERTY DEPT., 2600 TECHNOLOGY DRIVE SUITE 900, PLANO, TX, 75074, US

(21) Appl. No.: 10/079,453

(22) Filed: Feb. 22, 2002

Related U.S. Application Data
(60) Provisional application No. 60/270,617, filed on Feb. 23, 2001.

(51) Int. Cl. G02B 6/26; G02B 6/16; H01S 3/30

(52) U.S. Cl. 385/122; 385/123; 372/3; 359/334

(57) ABSTRACT

A dispersion management device utilizing a high order mode fiber, mode transformers, a trim fiber and a Raman pump configured to generate substantially complete dispersion and dispersion slope compensation for an attached optical span, without losses. The trim fiber is optimized for Raman amplification while completing the dispersion compensation of the high order mode fiber. The dispersion management device in one embodiment generates at least 5 dB of overall amplification. In one embodiment the trim fiber is a non-zero dispersion shifted fiber, while in another embodiment it is a reverse dispersion fiber. In yet another embodiment the trim fiber is dispersion shifted fiber. In yet another embodiment the trim fiber is standard SMF. In an exemplary embodiment the Raman pump comprises multiple sources, each of which are independently controlled, thus allowing for the operation without a variable optical attenuator. The mode transformer in a preferred embodiment is a transverse mode transformer.

### CROSS-REFERENCE TO RELATED APPLICATIONS

The present application claims the benefit of the filing date of copending U.S. Provisional Application, Serial No. 60/270,617 filed Feb. 23, 2001, entitled “Method and System for Dispersion Management with Raman Amplification” and incorporates by reference co-pending U.S. patent application Ser. No. 09/248,969 filed Feb. 12, 1999 entitled “Transverse Spatial Mode Transformer for Optical Communication” and co-pending U.S. patent application Ser. No. 09/249,830 filed Feb. 12, 1999 entitled “Optical Communication System with Chromatic Dispersion Compensation”.

### BACKGROUND OF THE INVENTION

Optical fiber has become increasingly important in many applications involving the transmission of light. When a pulse of light is transmitted through an optical fiber, the energy follows a number of paths which cross the fiber axis at different angles. A group of paths which cross the axis at the same angle is known as a mode. The fundamental mode, also known as the LP₀₁ mode, is the mode in which light passes substantially along the fiber axis. Modes other than the LP₀₁ mode, are known as high order modes. Fibers which have been designed to support only one mode with minimal loss, the LP₀₁ mode, are known as single mode fibers. High order modes exhibit characteristics which may be significantly different than the characteristics of the fundamental mode. There exists both even and odd high order modes. Even high order modes exhibit circular symmetry, and are thus ideally suited to circular waveguides such as optical fibers.

A multi-mode fiber is a fiber whose design supports multiple modes, and typically supports over 100 modes. A few-mode fiber is a fiber designed to support only a very limited number of modes. For the purpose of this patent, we will define a few mode fiber as a fiber supporting no more than 20 modes at the operating wavelength. Few mode fibers designed to have specific characteristics in a mode other than the fundamental mode are also known as high order mode (HOM) fibers. Fibers may carry different numbers of modes at different wavelengths, however in telecommunications the typical wavelengths are near 1310 nm and 1550 nm.

As light traverses the optical fiber, different wavelengths travel at different speeds, which leads to chromatic dispersion. This limits the bit rate at which information can be carried through an optical fiber. The effect of chromatic dispersion on the optical signal becomes more critical as the bit rate increases. Chromatic dispersion in an optical fiber is the sum of material dispersion and the waveguide dispersion and is defined as the differential of the group velocity in relation to the wavelength and is expressed in units of picosecond/nanometer (ps/nm). Optical fibers are often characterized by their dispersion per unit length of 1 kilometer, which is expressed in units of picosecond/nanometer/kilometer (ps/nm/km). For standard single mode fiber (SMF), dispersion at 1550 nm is typically on the order of 17 ps/nm/km.

The dispersion experienced by each wavelength of light is also different, and the differential of the dispersion in relation to wavelength is known as the slope, or second order dispersion, and is expressed in units of ps/nm². Optical fibers may be further characterized by their slope per unit length of 1 kilometer, which is expressed in units of picosecond/nanometer²/kilometer (ps/nm²/km).

At high bit rates, compensating for the slope is important so as to avoid “walk off”, which occurs when one wavelength in the band is properly compensated for, however other wavelengths in the operating band are left with significant dispersion due to the effect of the dispersion slope. The dispersion slope of standard SMF at 1550 nm is typically on the order of 0.06 ps/nm²/km.

In order to achieve the high performance required by today's communication systems, with their demand for ever increasing bit rates, it is necessary to reduce the effect of chromatic dispersion and slope. Several possible solutions are known to the art, including both active and passive methods of compensating for chromatic dispersion. One typical passive method involves the use of dispersion compensating fiber (DCF). DCF has dispersion properties that compensate for the chromatic dispersion inherent in optical communication systems. DCFs exist that are designed to operate on both the fundamental or lowest order mode (LP₀₁) and on higher order modes. Fibers designed to operate on higher order modes require the use of a mode converter so as to convert the optical signal from the fundamental mode to a high order mode. One desired property of DCF is that its dispersion should be of opposite sign of the dispersion of the transmission fiber that it is connected to. A large absolute value of dispersion of opposite sign reduces the length of fiber required to compensate for a large length of transmission fiber. Another desired property of a DCF is low optical signal attenuation. Ideally such a DCF should compensate for both chromatic dispersion and dispersion slope, and would be operative over the entire transmission bandwidth. The optical transmission bandwidth typically utilized is known as the “C” band, and is conventionally thought of as from 1525 nm-1565 nm. Longer wavelengths are also coming into usage, and are known as the “L” band, consisting of the wavelengths from 1565 nm-1610 nm.

Typical DCFs are designed as single mode fibers which support only the fundamental or lowest order spatial mode (LP₀₁) at typical operating wavelengths. Such fibers are typically characterized as having relatively low negative dispersion, high loss, limited compensation of slope, small A_{eff} and a resultant low tolerance for high power, and are designed to compensate for transmission fibers exhibiting positive dispersion and positive dispersion slope, i.e. the dispersion increasing with increasing wavelength and is above zero in the operative band. Higher order spatial modes are typically not supported (i.e. not guided) through the fiber.

Other transmission fibers have been designed which exhibit negative dispersion and positive slope over the transmission band. Such fibers are disclosed for example in U.S. Pat. No. 5,609,562 and are conventionally known as negative non-zero dispersion shifted fibers (negative NZDSF), or reverse dispersion fibers (RDF). These fibers exhibit zero dispersion at a wavelength above the “C” band, and typically exhibit positive dispersion slope. One type of RDF exhibits dispersion at 1550 nm of −1.32 ps/nm/km, with a slope of 0.053 ps/nm²/km.

One typical passive method of dispersion compensation involves the use of a dispersion compensating fiber (DCF) as shown in FIG. 1. However this method adds additional loss to the system. An improvement to the system involves adding Raman amplification to the DCF as shown in FIG. 2, so as to compensate for at least some of the loss associated with the DCF. Unfortunately, the gain of the Raman amplification and the dispersion which must be compensated by the DCF are not separately controllable in this method. The length of the DCF, which to a great extent determines the amount of amplification, is set by the need for dispersion compensation and not by the needs of the Raman amplifier. DCFs typically have a small effective area (A_{eff}) which limits the amount of pump power which can be used so as to avoid non-linear effects.

Another method for compensating for the dispersion and the slope of the optical span is described in copending U.S. application Ser. No. 09/248,969 whose contents are incorporated herein by reference and is illustrated in FIG. 3. A transverse mode transformer converts the light from the fundamental mode to a high order mode, which propagates through an optically connected high order mode (HOM) fiber. The HOM fiber exhibits dispersion and slope in the specific high order mode. The transverse mode transformer, as compared to other longitudinal mode transformers, is advantageous in that it exhibits a broad spectrum of operation. A separate trim fiber is utilized to adjust the dispersion and dispersion slope so as to compensate for the optical span. However this system suffers from loss occurring in the mode transformers, the high order mode fiber as well as the trim fiber.

There is therefore a long felt need for a method and system to both correct for the dispersion and slope, with the capability of minimizing loss.

### SUMMARY OF THE INVENTION

The aforementioned needs are addressed, by introducing Raman amplification to the trim fiber of the dispersion management device. Through the proper choice of lengths, pump power and trim fiber, the attenuation loss associated with dispersion management can be eliminated. In one embodiment, sufficient Raman amplification is achieved so as to accomplish at least 5 dB of overall amplification in the dispersion module. In another embodiment the Raman pumping is controlled so as to compensate for differential spectral gain/loss of the balance of the system thus obviating the need for a variable optical attenuator

In accordance with a preferred embodiment of the present invention, there is provided a dispersion management device comprising a mode transformer, a high order mode dispersion compensating fiber in optical communication with one port of the mode transformer, a trim fiber in optical communication with a second port of the mode transformer and a Raman pump in optical communication with the trim fiber, whereby the Raman pump generates gain in the trim fiber so as to overcome any losses associated with the mode transformer and the high order mode dispersion compensating fiber.

In an exemplary embodiment the mode transformer is a transverse mode transformer, comprising a phase element. In another embodiment, the mode transformer is a longitudinal mode transformer.

In an exemplary embodiment, the dispersion management device further comprises a wavelength division multiplexer for optically connecting the Raman pump to the trim fiber. In one embodiment the dispersion management device generates a net gain of at least 5 dB.

In an exemplary embodiment, the Raman pump comprises multiple sources, each of which is independently controllable. In another embodiment the wavelength and power of each of the multiple sources are modified so as to maintain a design gain shape.

In an exemplary embodiment, the trim fiber is a reverse dispersion fiber. In another embodiment, the trim fiber is a dispersion shifted fiber, while in yet another embodiment the trim fiber is a non-zero shifted dispersion fiber. In another embodiment the trim fiber is a standard SMF, optimized for transmission in the 1310 nm band.

The present invention also relates to a method of dispersion management providing gain comprising the steps of providing a mode transformer, providing a high order mode dispersion compensating waveguide in optical communication with one port of the mode transformer, providing a trim fiber in optical communication with a second port of the mode transformer and a Raman pump in optical communication with the trim fiber, whereby the Raman pump provides gain to an optical signal propagating in the trim fiber so as to overcome any losses in the dispersion management device and produce a net gain for the optical signal.

### BRIEF DESCRIPTION OF THE DRAWINGS

The above and further advantages of the present invention may be better understood by referring to the following description taken in conjunction with the accompanying drawings in which like numerals designate corresponding elements or sections throughout, and in which:

FIG. 1 illustrates a prior art system of compensating for dispersion in an optical span;

FIG. 2 illustrates a prior art system of dispersion compensation with Raman amplification to minimize attenuation;

FIG. 2a illustrates another embodiment of a prior art system of dispersion compensation with Raman amplification to minimize attenuation;

FIG. 3 illustrates a system of dispersion compensation utilizing a high order mode fiber and a trim fiber;

FIG. 4 illustrates a first embodiment of a system designed to compensate for dispersion with Raman amplification;

FIG. 4a illustrates a second embodiment of a system designed to compensate for dispersion with Raman amplification;

FIG. 5 illustrates a system designed to compensate for dispersion with Raman amplification, containing an optical add/drop;

FIG. 6a illustrates a dispersion map for a first embodiment of dispersion management device 190, and

FIG. 6b illustrates a dispersion map for a second embodiment of dispersion management device 190.

### DETAILED DESCRIPTION OF THE INVENTION

FIG. 1 illustrates a prior art system 10 for compensating for dispersion and attenuation in an optical span, comprising optical signals 5 and 5′, optical span 20, optical amplifier/dispersion compensator 90 comprising optical pre-amplifier 30, optical isolator 40, gain flattening filter (GFF) 50, variable optical attenuator (VOA) 60, DCF 70 and optical power amplifier 80. First optical span 20, which carries optical signal 5 is connected to the input of optical pre-amplifier 30, at the input of optical amplifier/dispersion compensator 90. The output of optical pre-amplifier 30 is connected to the input of optical isolator 40. The output of optical isolator 40 is connected to the input of GFF 50, and the output of GFF 50 is connected to the input of VOA 60. The output of VOA 60 is connected to a first end of DCF 70, and a second end of DCF 70 is connected to the input of optical power amplifier 80. The output of optical amplifier 80 is connected at the output of optical amplifier/dispersion compensator 90 to one end of second optical span 20 which carries optical signal 5′.

In operation, first optical span 20, which in an exemplary model consists of approximately 80 kilometers of optical transmission fiber, carries an optical signal 5, which typically consists of a wavelength division multiplexed signal consisting of many separate wavelengths. In one embodiment optical span 20 is pumped in a counter-propagating direction by a Raman pump source (not shown) to provide distributed amplification. Optical signal 5 experiences attenuation and dispersion incurred while transiting optical span 20, and thus requires dispersion compensation as well as amplification, which is to be accomplished by optical amplifier/dispersion compensator 90. Optical span 20 is connected to optical pre-amplifier 30, the first stage of optical amplifier/dispersion compensator 90, which amplifies optical signal 5, and its output is connected to optical isolator 40 which prevents any reflected signals from traveling back to optical amplifier 30. Any backward signal flow will degrade the signal to noise ratio in the pre-amplifier due to amplified spontaneous emission (ASE). The output of optical isolator 40 is connected to the input of GFF 50 which compensates for the uneven gain across the spectrum of the optical pre-amplifier 30, and its output is connected to VOA 60 which functions to limit the amount of signal power being introduced into DCF 70. VOA 60 also functions to compensate for input power variations, and to maintain the design gain shape. DCF 70 exhibits a small effective area, and therefore large signal power will incur significant non-linear effects. The output of variable optical attenuator 60 is connected to DCF 70 which acts to compensate for the dispersion in the signal, and its output is connected to power amplifier 80, which amplifies the signal prior to injecting the amplified and dispersion corrected signal 5′ into the next optical span 20. In a typical system the overall gain of the optical amplifier/dispersion compensator 90 is 20 dB.

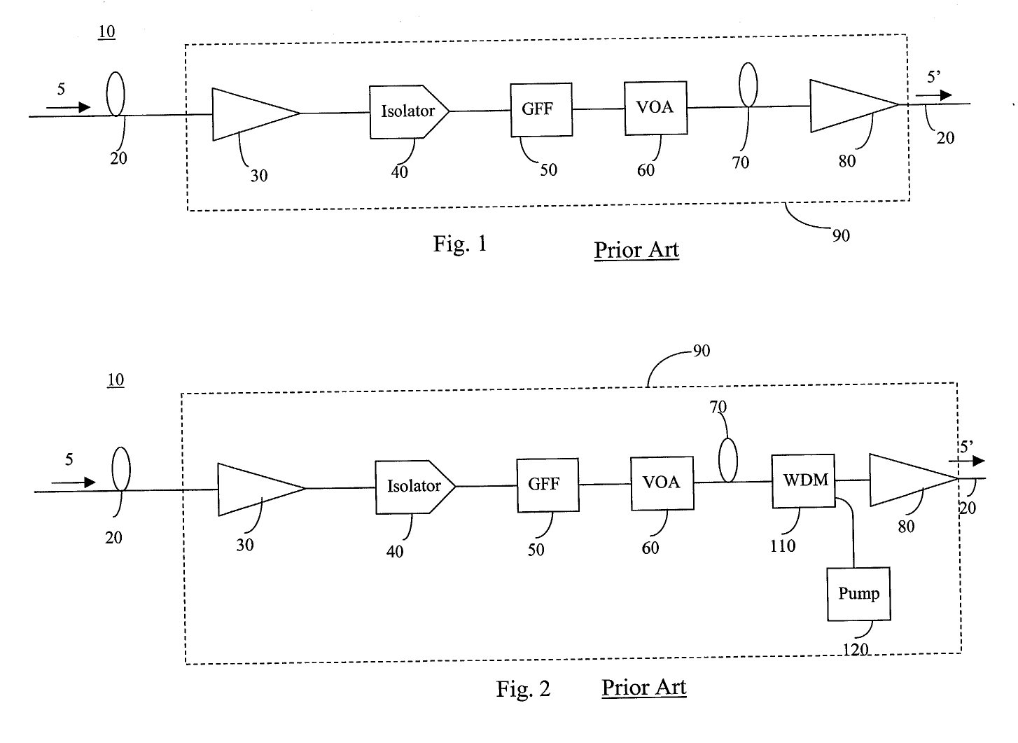

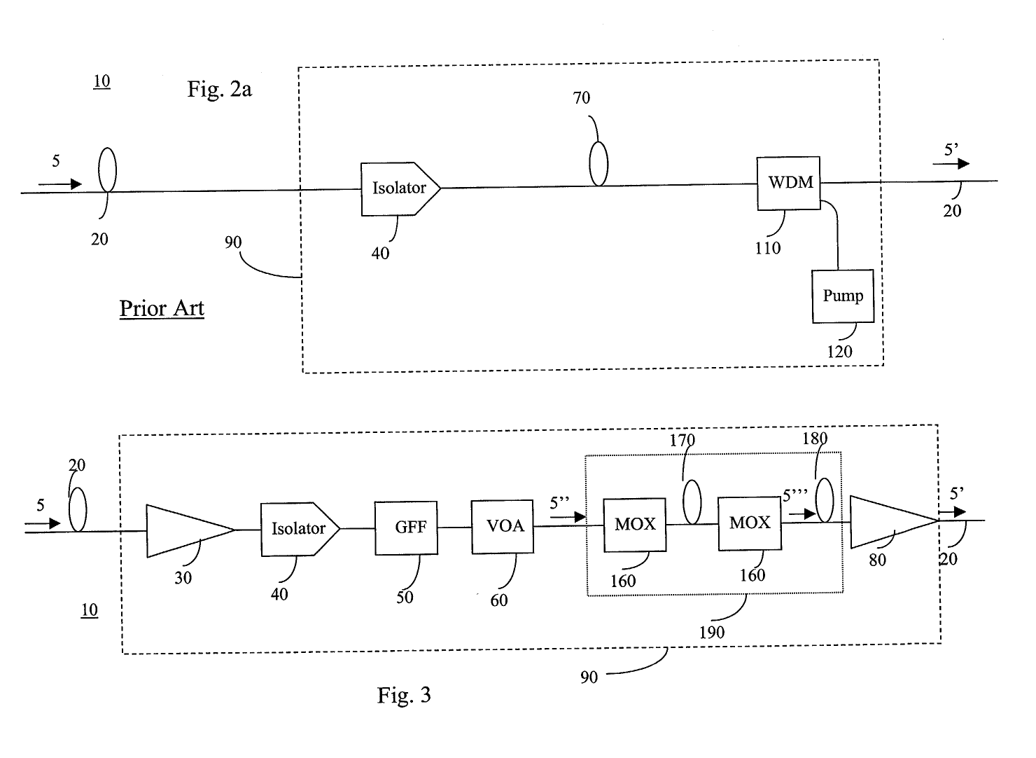

FIG. 2 illustrates a prior art system 10 designed to improve the performance of the system 10 of FIG. 1 by compensating for the attenuation experienced by the signal in DCF 70. Prior art system 10 comprises optical spans 20, optical signal 5 and 5′ and optical amplifier/dispersion compensator 90 comprising optical pre-amplifier 30, optical isolator 40, GFF 50, VOA 60, DCF 70, wave division multiplexer (WDM) 110, Raman pump 120, and optical power amplifier 80. First optical span 20, which carries optical signal 5 is connected to the input of optical pre-amplifier 30, at the input of optical amplifier/dispersion compensator 90. The output of optical pre-amplifier 30 is connected to the input of optical isolator 40. The output of optical isolator 40 is connected to the input of GFF 50, and the output of GFF 50 is connected to the input of VOA 60. The output of VOA 60 is connected to a first end of DCF 70, and a second end of DCF 70 is connected to one port of WDM 110. The output of Raman pump 120 is connected to a second port of WDM 110 and the output of WDM 110 is connected to the input of optical power amplifier 80. The output of optical power amplifier 80 is connected at the output of optical amplifier/dispersion compensator 90 to one end of second optical span 20 which carries optical signal 5′.

In operation the system 10 operates as described above in relation to the system 10 of FIG. 1 with the exception of the addition of Raman pump 120 and WDM 110. Raman pump 120 is connected through WDM 110 to DCF 70 so as to add Raman amplification to the optical signal as it traverses DCF 70. This Raman amplification compensates for the losses caused by DCF 70 and adds a small amount of gain, on the order of 5 dB. This Raman gain in an exemplary embodiment adds to the overall gain of amplifier 90. The output of DCF 70 is connected through WDM 110 to power amplifier 80, which amplifies the signal prior to injecting the amplified and dispersion corrected signal 5′ into the next optical span 20. The overall gain of a typical amplifier 90 with Raman pumped DCF 70 in the exemplary embodiment is thus 25 dB. In another embodiment the Raman gain allows for a different design of the optical amplifier stages 30 and 80 while retaining the same overall gain of amplifier 90 of FIG. 1.

The effective area (A_{eff}) of DCF 70 is typically small, and in order to avoid non-linear effects the power of Raman pump 120 must be strictly limited. It is to be noted however, that if the power is too low, the signal to noise ratio (SNR) is poor, and as a result the amplification achieved is at a significant cost of noise. The length of DCF 70 is fixed by the requirement for dispersion compensation of the signal 5, and is based on the characteristics of optical span 20 and the characteristics of the DCF 70, and as a result can not be varied in accordance with the amplification requirements. Design and successful operation of such a system is therefore quite difficult, with many restraining factors and few if any degrees of freedom.

FIG. 2a illustrates another embodiment of a prior art system 10 for compensating for dispersion and attenuation in an optical span in which the erbium doped fiber amplification of FIG. 2 is replaced with Raman amplification. System 10 comprises optical signals 5 and 5′, optical span 20 and optical amplifier/dispersion compensator 90 comprising optical isolator 40, DCF 70, WDM 110 and Raman pump 120. First optical span 20, which carries optical signal 5 is connected to the input of optical isolator 40 at the input to optical amplifier/dispersion compensator 90, and the output of optical isolator 40 is connected to a first end of DCF 70. A second end of DCF 70 is connected to one port of WDM 110. The output of Raman pump 120 is connected to a second port of WDM 110, and the output of WDM 110 is connected at the output of optical amplifier/dispersion compensator 90 to one end of second optical span 20 which carries optical signal 5′.

In operation, first optical span 20, which in an exemplary model consists of approximately 80 kilometers of optical transmission fiber, carries an optical signal 5, which typically consists of a wavelength division multiplexed signal consisting of many separate wavelengths. In an exemplary embodiment optical span 20 is pumped in a counter-propagating direction by a Raman pump source (not shown) to provide distributed amplification. Optical signal 5 experiences dispersion while transiting optical span 20, and thus requires dispersion compensation, while any losses to be incurred by dispersion compensation are to be minimized. Optical span 20 is connected to optical amplifier/dispersion compensator 90 which comprises optical isolator 40 at its input to prevent any reflected signals from traveling back to optical span 20. The output of optical isolator 40 is connected to DCF 70 which acts to compensate for the dispersion in the signal, while at the same time, DCF 70 is connected by way of WDM 110 to Raman pump 120. Raman pump 120 amplifies the signal as it traverses DCF 70, thus minimizing any losses incurred. In an exemplary embodiment, the signal experiences net gain while traversing DCF 70. The output of DCF 70 is connected through WDM 110 at the output of optical amplifier/dispersion compensator 90 to the next optical span 20. A disadvantage of this system is that the length of DCF 70 required is determined by the dispersion of optical span 20, and the maximum amount of power which can be input by Raman pump 120 is strictly limited due to the small A_{eff} of DCF 70. It is thus quite difficult to both maximize the amplification as well as completely compensate for the dispersion.

FIG. 3 illustrates a system 10 comprising optical amplifier/dispersion compensator 90 designed to compensate for dispersion and dispersion slope utilizing a high order mode fiber 170. The system 10 comprises optical spans 20 carrying optical signal 5 and 5′ and optical amplifier/dispersion compensator 90 comprising optical pre-amplifier 30, optical isolator 40, GFF 50, VOA 60, optical signals 5″ and 5′″, optical power amplifier 80 and dispersion management device 190 comprising first mode transformer 160, high order mode fiber 170, second mode transformer 160 and trim fiber 180. First optical span 20, which carries optical signal 5 is connected to the input of optical pre-amplifier 30, at the input of optical amplifier/dispersion compensator 90. The output of optical pre-amplifier 30 is connected to the input of optical isolator 40. The output of optical isolator 40 is connected to the input of GFF 50, and the output of GFF 50 is connected to the input of VOA 60. The output of VOA 60 carrying signal 5″ is connected the input of first mode converter 160 at the input to dispersion management device 190, and the output of first mode converter 160 is connected to a first end of high order mode fiber 170. A second end of high order mode fiber 170 is connected to the input of second mode converter 160. The output of second mode converter 160, carrying optical signal 5′″ is connected to one end of trim fiber 180, and the second end of trim fiber 180 is connected at the output of dispersion management device 190 to the input of optical power amplifier 80. The output of optical power amplifier 80 is connected at the output of optical amplifier/dispersion compensator 90 to one end of second optical span 20 which carries optical signal 5′.

In operation, first optical span 20, which in an exemplary model consists of approximately 80 kilometers of optical transmission fiber, carries an optical signal 5, which typically consists of a wavelength division multiplexed signal consisting of many separate wavelengths. In one embodiment optical span 20 is pumped in a counter-propagating direction by a Raman pump source (not shown) to provide distributed amplification. Optical signal 5 experiences attenuation and dispersion incurred while transiting optical span 20, and thus requires dispersion compensation as well as amplification, which is to be accomplished by optical amplifier/dispersion compensator 90. Optical span 20 is connected to optical pre-amplifier 30, the first stage of optical amplifier/dispersion compensator 90, which amplifies optical signal 5, and its output is connected to optical isolator 40 which prevents any reflected signals from traveling back to optical amplifier 30. Any backward signal flow will degrade the signal to noise ratio in the pre-amplifier due to ASE. The output of optical isolator 40 is connected to the input of GFF 50 which compensates for the uneven gain across the spectrum of the optical pre-amplifier 30, and its output is connected to VOA 60 which functions to compensate for input power variations, and to maintain the design gain shape. An interesting aspect of the amplifier 90 of FIG. 3 is that due to the large effective area of HOM fiber 170, there is no need to limit the amount of signal power being introduced into dispersion management device 190.

The output of VOA 60, carrying pre-amplified signal 5″ is connected to the input of dispersion management device 190, comprising mode transformers 160, HOM fiber 170 and trim fiber 180. In an exemplary embodiment dispersion management device 190 is of the type described in copending U.S. patent application Ser. No. 09/249,830 filed Feb. 12, 1999 and U.S. Pat. No. 6,339,665 whose contents are incorporated herewith by reference. Mode transformers 160 are in an exemplary embodiment transverse mode transformers comprising at least one phase element of the type described in copending U.S. patent application Ser. No. 09/248,969 whose contents are incorporated herein by reference. The use of a transverse mode transformer is advantageous as it allows for a broad band of operation with low loss. In another embodiment, a longitudinal mode transformer is utilized. The output of VOA 60, is thus connected to the input of first mode transformer 160 which functions to convert the signal 5″ substantially completely to a single high order mode, and the output of first mode transformer 160 is connected to one end of HOM fiber 170. HOM fiber 170 comprises a fiber designed to exhibit dispersion and preferably dispersion slope characteristics substantially the opposite of the dispersion and dispersion slope characteristics of first optical span 20. It is important to note that the dispersion and slope characteristics are not completely matched by HOM fiber 170, and the precise match is accomplished through trim fiber 180 as will be further described below. The output of HOM fiber 170 is connected to the input of second mode transformer 160, which reconverts the signal to the fundamental mode. The output of second mode transformer 160 is connected to trim fiber 180, which is designed to complete the dispersion compensation of the signal 5′″ in a manner described in U.S. Pat. No. 6,339,665 and in particular FIGS. 10a, 10b, 11a, 11b, 11c and 11d and the discussions thereto, which is incorporated herewith by reference, and as described below. The combination of trim fiber 180 and HOM fiber 170 operate to fully compensate for both the dispersion and dispersion slope of attached optical span 20.

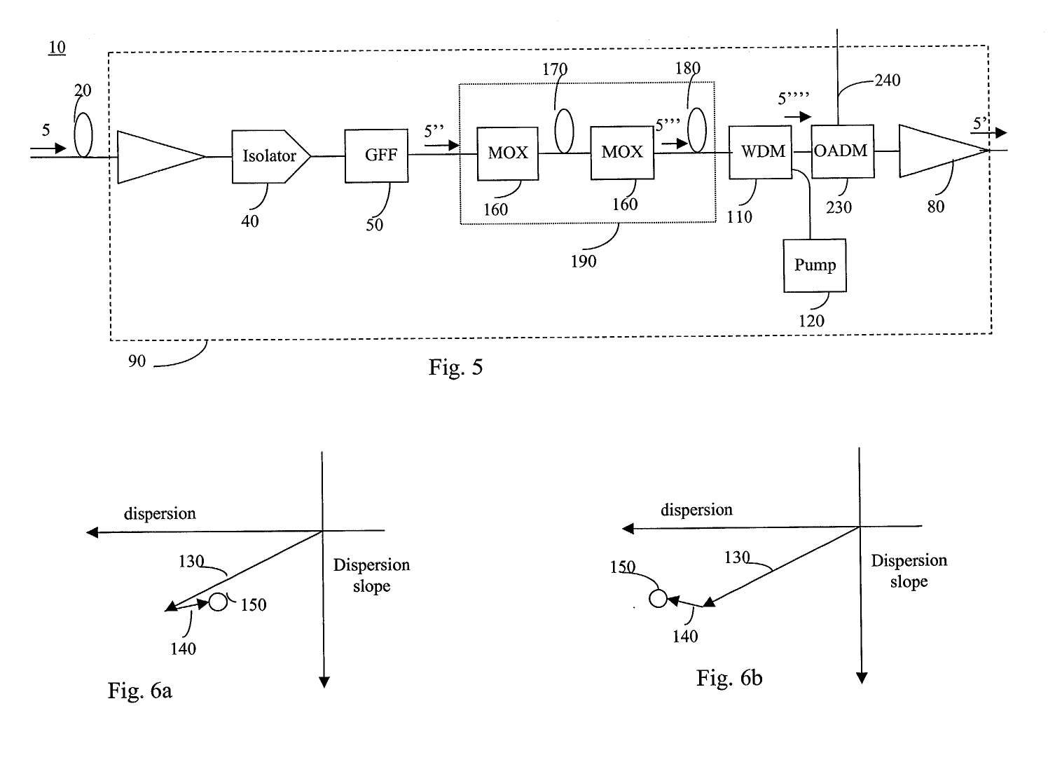

FIG. 6a illustrates a map of the dispersion and dispersion slope for a first embodiment of the dispersion management device 190 of FIG. 3, in which the x-axis represents dispersion and the y-axis represents dispersion slope. Line 130 represents the negative dispersion and slope of HOM fiber 170, and line 140 represents the dispersion and slope of trim fiber 180. The length of line 130 represents the length of HOM fiber 170, and the length of line 140 represents the length of trim fiber 180. Point 150 represent graphically the required negative dispersion and slope to fully compensate for first optical span 20. HOM fiber 170 overcompensates for the dispersion and somewhat for the slope, and the overcompensation is corrected by the presence of trim fiber 180. The length and characteristics of trim fiber 180 are chosen such that the combination of HOM fiber 170 and trim fiber 180 substantially compensate for the dispersion and slope of first optical span 20. In the exemplary embodiment shown trim fiber 180 comprises a length of standard SMF. In an alternative embodiment (not shown) a pre-determined amount of residual dispersion and/or slope may be desired and the dispersion and/or slope of optical span 20 is thus not fully compensated for by dispersion management device 190.

FIG. 6b illustrates a map of the dispersion and dispersion slope for a second embodiment of the dispersion management device 190 of FIG. 3, in which the x-axis represents dispersion and the y-axis represents dispersion slope. Line 130 represents the negative dispersion and slope of HOM fiber 170, and line 140 represents the dispersion and slope of trim fiber 180. The length of line 130 represents the length of HOM fiber 170, and the length of line 140 represents the length of trim fiber 180. Point 150 graphically represents the required negative dispersion and slope to filly compensate for first optical span 20. HOM fiber 170 under compensates for the dispersion and overcompensates for the slope, and is corrected by the presence of trim fiber 180. The length and characteristics of trim fiber 180 are chosen such that the combination of HOM fiber 170 and trim fiber 180 substantially compensate for the dispersion and slope of first optical span 20. In the exemplary embodiment shown trim fiber 180 comprises a length of RDF. In another embodiment trim fiber 180 comprises dispersion shifted fiber, which acts to correct the slope and minimally impacts the dispersion. In yet another embodiment, trim fiber 180 comprises standard SMF. In an alternative embodiment (not shown) a pre-determined amount of residual dispersion and/or slope is desired, and the dispersion and/or slope of optical span 20 is not fully compensated for by dispersion management device 190.

Referring back to FIG. 3, the output of trim fiber 180 is connected in an exemplary embodiment to optical power amplifier 80 at the output of dispersion management device 190, which amplifies the signal and outputs the amplified and dispersion corrected signal 5′ to the next optical span 20. In another embodiment the next optical span is replaced with a receiver which converts the optical signal to an electrical signal. Optical power amplifier 80 must compensate for any losses incurred in high order mode dispersion compensating device 190, as well as any residual attenuation from GFF 50, isolator 40 and optical span 20.

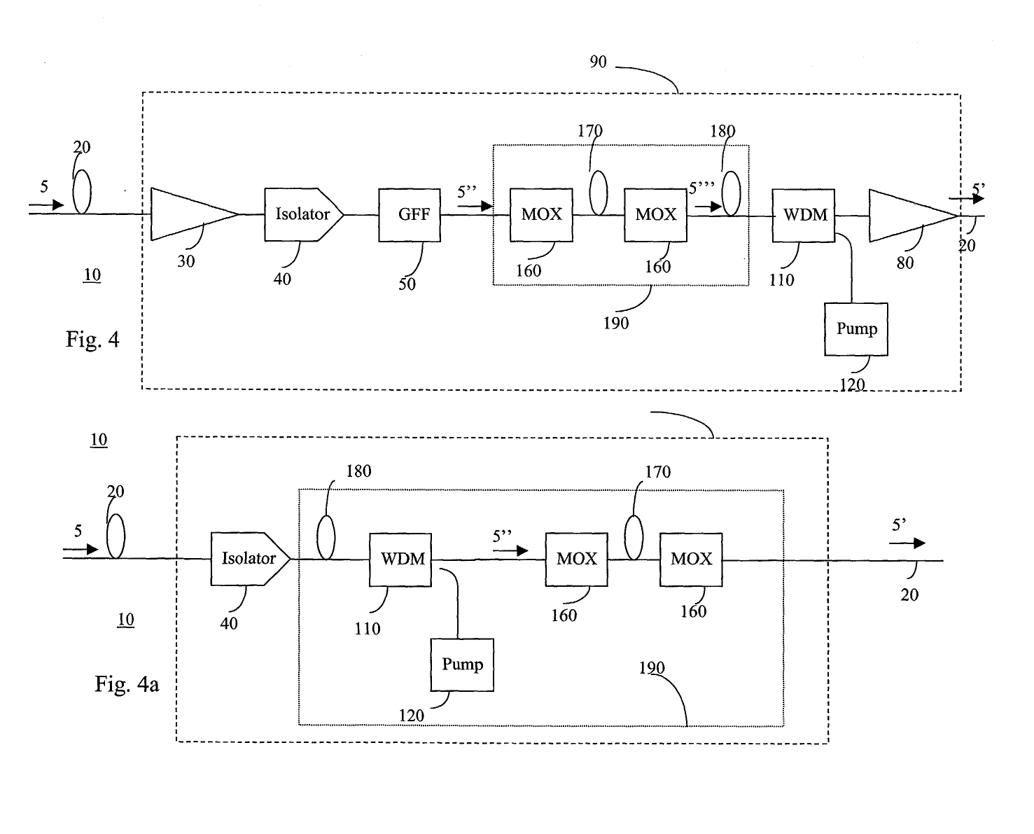

FIG. 4 illustrates the system of FIG. 3 with a first embodiment of the invention, which compensates for the losses incurred in the high order mode dispersion management device 190. It further offers the advantage of being able to supply overall amplification to the system as will be discussed further below. The system 10 comprises optical spans 20 and optical amplifier/dispersion compensator 90 comprising optical pre-amplifier 30, optical isolator 40, GFF 50, dispersion management device 190 comprising mode transformers 160, HOM fiber 170, and trim fiber 180, Raman pump 120, WDM 110 and power optical amplifier 80. First optical span 20, which carries optical signal 5 is connected to the input of optical pre-amplifier 30, at the input of optical amplifier/dispersion compensator 90. The output of optical pre-amplifier 30 is connected to the input of optical isolator 40. The output of optical isolator 40 is connected to the input of GFF 50, and the output of GFF 50 carrying signal 5″ is connected the input of first mode converter 160 at the input to dispersion management device 190. The output of first mode converter 160 is connected to a first end of HOM fiber 170, and a second end of HOM fiber 170 is connected to the input of second mode converter 160. The output of second mode converter 160, carrying optical signal 5′″ is connected to one end of trim fiber 180, and the second end of trim fiber 180 is connected at the output of dispersion management device 190 to one port of WDM 110. The output of Raman pump 120 is connected to a second port of WDM 110, and the output of WDM 110 is connected to the input of optical power amplifier 80. The output of optical power amplifier 80 is connected at the output of optical amplifier/dispersion compensator 90 to one end of second optical span 20 which carries optical signal 5′.

In operation the amplifier 90 of FIG. 4 is similar to that of amplifier 90 of FIG. 3 with the exception of the addition of Raman amplification to the trim fiber 180. Raman pump 120 provides amplification by counter-propagating Raman pump energy so as to amplify signal 5′″ propagating in trim fiber 180. Trim fiber 180 in one embodiment comprises standard SMF, which has a large positive dispersion and a low dispersion slope. However, SMF exhibits a large A_{eff}, and is thus inefficient as a Raman amplifier. To compensate for the large effective area more power is required of the Raman pump 120 than would be required if a trim fiber of a smaller effective area was utilized. In another embodiment, fiber with a smaller A_{eff} is utilized as trim fiber 180 thus allowing for a lower pump power. In an exemplary embodiment the trim fiber 180 comprises non-zero dispersion shifted fiber. In another exemplary embodiment the trim fiber 180 comprises RDF, also know as negative non-zero dispersion shifted fibers (negative NZDSF). In another embodiment a fiber is designed with added doping, such as with Germanium to maximum the Raman amplification, while maintaining a large effective area so as to minimize non-linear effects. The added degree of flexibility obtained by utilizing a separate trimming fiber, which is pumped, is an important aspect of the invention.

It is important to note that the need for amplification may be considered in choosing the combination of fibers 180 and 170 of dispersion management device 190 of FIG. 4. Thus if a fiber 180 with specific Raman gain amplification characteristics is utilized, a different high order mode fiber 170, which results in complete dispersion and slope compensation of signal 5 is chosen.

It is still another important aspect of the invention that VOA 60 is not required in amplifier 90 of FIG. 4, because the Raman amplification can be controlled by modifying the wavelength and power of Raman pump 120 to maintain the design gain shape, and the large effective area of dispersion management device 190, primarily a result of the large A_{eff} of HOM fiber 170, prevents non-linear effects. The added amplification increases the dynamic range of both the span power and also allows for mid-stage access.

In another embodiment, Raman pump 120 comprises a combination of a few Raman pumps, e.g. 1460 and 1480 nanometer pumps, the power of each of which is independently controlled. By controlling the power balance of different channels, the balancing effect of a VOA can be achieved. The variable gain range is on the order of 5-9 dB, which is sufficient to compensate for the loss budget associated with optical add/drop multiplexer (OADM) devices.

FIG. 4a illustrates another embodiment of the invention. The system 10 comprises optical spans 20 and optical amplifier/dispersion compensator 90 comprising optical isolator 40 and dispersion management device 190 comprising trim fiber 180, Raman pump 120, WDM 110, mode transformers 160 and HOM fiber 170. First optical span 20, which carries optical signal 5 is connected to the input of optical isolator 40, at the input of optical amplifier/dispersion compensator 90. The output of optical isolator 40 is connected at the input of dispersion management device 190 to one end of trim fiber 180, and the second end of trim fiber 180 is connected to one port of WDM 110. The output of Raman pump 120 is connected to a second port of WDM 110, and the output of WDM 110 carrying signal 5″ is connected to the input of first mode converter 160. The output of first mode converter 160 is connected to a first end of high order mode fiber 170, and a second end of high order mode fiber 170 is connected to the input of second mode converter 160. The output of second mode converter 160 is connected at the output of dispersion management device 190 and the output of optical amplifier/dispersion compensator 90 to one end of second optical span 20 which carries optical signal 5′.

In operation, first optical span 20, which in an exemplary model consists of approximately 80 kilometers of optical transmission fiber, carries an optical signal 5, which typically consists of a wavelength division multiplexed signal consisting of many separate wavelengths. In an exemplary embodiment optical span 20 is pumped in a counter-propagating direction by a Raman pump source (not shown) to provide distributed amplification. Optical signal 5 experiences dispersion while transiting optical span 20, and thus requires dispersion compensation, while any losses to be incurred by dispersion compensation are to be minimized. Optionally, optical amplifier/dispersion compensator 90 is to supply some amount of amplification. Optical span 20 is connected to optical amplifier/dispersion compensator 90 which comprises optical isolator 40 at its input to prevent any reflected signals from traveling back to optical span 20. The output of optical isolator 40 is connected at the input to dispersion management device 190 to trim fiber 180 which is a fiber optimized for Raman amplification, while complementing and completing the dispersion compensation of HOM fiber 170. Trim fiber 180 is connected by way of WDM 110 to Raman pump 120, which adds energy to signal 5 as it traverses trim fiber 180 thus amplifying the signal in advance of any losses that may be incurred in mode converters 160 and HOM fiber 170.

The output of WDM 110 carrying amplified signal 5″ is connected to the input of first mode converter 160, which acts to convert the signal 5″ from the fundamental mode substantially to a single high order mode. In an exemplary embodiment the high order mode is the LP₀₂ mode. The output of first mode converter 160 is connected to HOM fiber 170, which is designed to compensate for the dispersion and/or the dispersion slope of the signal 5, as described above in relation to FIG. 6a and FIG. 6b. An important aspect of the invention is the ability to separately optimize trim fiber 170 for Raman amplification, and HOM fiber 170 for dispersion compensation. The combination of dispersion and dispersion slope experienced by the signal as it traverses HOM fiber 170 and trim fiber 180 is designed in an exemplary embodiment to fully compensate for the dispersion of signal 5. In another embodiment a pre-determined amount of residual dispersion and/or dispersion slope is designed in and the dispersion and/or slope of first span 20 is not fully compensated.

Amplification experienced in trim fiber 180 is designed to achieve the maximum amount of gain achievable without experiencing signal distortion. The large A_{eff} of HOM fiber 170 allows for complete dispersion compensation of amplified signal 5″, without experiencing the penalties of non-linear effects, and the low loss of the combination of mode transformers 160 and HOM fiber 170 allow for signal 5 to be fully compensated and quite close to the maximum level allowable by the combination of trim fiber 180 and Raman pump 120.

In an exemplary embodiment the trim fiber 180 comprises non-zero dispersion shifted fiber. In another exemplary embodiment the trim fiber 180 comprises RDF, also know as negative non-zero dispersion shifted fibers (negative NZDSF). In another embodiment a fiber is designed with added doping, such as with Germanium to maximum the Raman amplification, while maintaining a large effective area so as to minimize non-linear effects. In another embodiment, trim fiber 180 comprises standard SMF. In still another embodiment, trim fiber 180 comprises conventional dispersion compensating fiber with a small A_{eff}, and dispersion of approximately −80 ps/nm/km. The added degree of flexibility obtained by utilizing a separate trimming fiber, which is pumped, is an important aspect of the invention.

It is important to note that the need for amplification may be considered in choosing the combination of fibers 180 and 170 of dispersion management device 190 of FIG. 4a. Thus if a fiber 180 with specific Raman gain amplification characteristics is utilized, a different high order mode fiber 170, which results in complete dispersion and slope compensation of signal 5 is chosen. The order of placement of the trim fiber 180 with its associated Raman pump 120 and the HOM fiber 170 of FIG. 4a is not critical and trim fiber 180 may be placed after HOM fiber 170 without exceeding the scope of the invention.

FIG. 5 illustrates the system of FIG. 4 with the addition of an OADM 230. The system 10 comprises optical spans 20 and optical amplifier/dispersion compensator 90 comprising optical pre-amplifier 30, optical isolator 40, gain flattening filter 50, dispersion management device 190 comprising mode transformers 160, HOM fiber 170, and trim fiber 180, Raman pump 120, WDM 110 and power optical amplifier 80. First optical span 20, which carries optical signal 5 is connected to the input of optical pre-amplifier 30, at the input of optical amplifier/dispersion compensator 90. The output of optical pre-amplifier 30 is connected to the input of optical isolator 40. The output of optical isolator 40 is connected to the input of gain flattening filter 50, and the output of gain flattening filter 50 carrying signal 5″ is connected the input of first mode converter 160 at the input to dispersion management device 190. The output of first mode converter 160 is connected to a first end of high order mode fiber 170, and a second end of high order mode fiber 170 is connected to the input of second mode converter 160. The output of second mode converter 160, carrying optical signal 5′″ is connected to one end of trim fiber 180, and the second end of trim fiber 180 is connected at the output of dispersion management device 190 to one port of WDM 110. The output of Raman pump 120 is connected to a second port of WDM 110, and the output of WDM 110, carrying optical signal 5″″ is connected to the input of OADM 230. One output of OADM 230 is connected to the input of optical power amplifier 80. Output 240 of OADM 230 is available for connection to a local optical network. The output of optical power amplifier 80 is connected at the output of optical amplifier/dispersion compensator 90 to one end of second optical span 20 which carries optical signal 5′.

In operation, amplifier 90 of FIG. 5 is similar to that of amplifier 90 of FIG. 4, with the exception that specific wavelengths of optical signal 5′″ are added or dropped at OADM 230. The use of OADM 230 is known to those skilled in the art, and connection 240 is provided so as to allow for the connection of the amplifier 90 to a local network which is in need of adding or receiving signals of a specific wavelength from optical signal 5. OADM 230 is added after dispersion compensation is completed so that any signal being dropped onto fiber 240 will have been properly compensated prior to being dropped from the data stream. Furthermore, any signal being added from fiber 240 will be added with a zero dispersion, and will therefore be in a matched condition to the data stream signal 5″″ which has now been fully compensated. Losses associated with OADM 230 are compensated for by the extra gain provided by Raman pump 120.

The minimization of dispersion accumulation and added power budget of a Raman pumped high order mode dispersion management device comprising a transverse mode transformer, enables a dynamic optical network where optical add/drop multiplexing, optical protection switching and optical switching fabric can be implemented.

Having described the invention with regard to certain specific embodiments thereof, it is to be understood that the description is not meant as a limitation, since further modifications may now suggest themselves to those skilled in the art, and it is intended to cover such modifications as fall within the scope of the appended claims.

We claim:

1. A dispersion management device which produces gain for an optical signal comprising;
a mode transformer;
a high order mode dispersion compensating fiber in optical communication with a first port of said mode transformer;
a trim fiber in optical communication with a second port of said mode transformer, and a Raman pump in optical communication with said trim fiber;
whereby said Raman pump produces gain in an optical signal propagating in said trim fiber, and whereby said gain exceeds any losses incurred in said mode transformer and said high order mode dispersion compensating fiber thereby producing a net gain for said optical signal.

2. The dispersion management device of claim 1 further comprising a wavelength division multiplexer optically connecting said Raman pump to said trim fiber.

3. The dispersion management device of claim 1 whereby said net gain is at least 5 dB.

4. The dispersion management device of claim 1 whereby said Raman pump comprises multiple pump sources, the power of each of said multiple pump sources being independently controllable.

5. The dispersion management device of claim 4 wherein the power and wavelength of said multiple sources are independently controlled so as to maintain a predetermined design gain shape.

6. The dispersion management device of claim 1 wherein said trim fiber is a reverse dispersion fiber.

7. The dispersion management device of claim 1 wherein said trim fiber is a non-zero dispersion shifted fiber.

8. The dispersion management device of claim 1 wherein said trim fiber is a dispersion shifted fiber.

9. The dispersion management device of claim 1 wherein said mode transformer is a transverse mode transformer.

10. The dispersion management device of claim 1 wherein said mode transformer is a longitudinal mode transformer.

11. A method of dispersion management exhibiting gain for an optical signal, said method comprising the steps of;
supplying a mode transformer;
supplying a high order mode dispersion compensating fiber in optical communication with a first port of said mode transformer;
supplying a trim fiber in optical communication with a second port of said mode transformer;
supplying a Raman pump in optical communication with said trim fiber;
pumping said trim fiber with energy from said Raman pump to produce gain in an optical signal propagating in said trim fiber,
whereby said gain exceeds any losses incurred in said mode transformer and said high order mode dispersion compensating fiber, thereby producing a net gain for said optical signal.

12. The method of claim 10 further comprising the step of supplying a wavelength division multiplexer optically connecting said Raman pump to said trim fiber.

13. The method of claim 10 whereby said net gain is at least 5 dB.

14. The method of claim 10 whereby said Raman pump comprises multiple pump sources, the power output of each of said multiple pump sources being independently controllable.

15. The method of claim 14 whereby the power and wavelength of said multiple sources are independently controlled so as to maintain a predetermined design gain shape.

16. The method of claim 10 wherein said trim fiber is a reverse dispersion fiber.

17. The method of claim 10 wherein said trim fiber is a non-zero dispersion shifted fiber.

18. The method of claim 10 wherein said trim fiber is a dispersion shifted fiber.

19. The method of claim 10 wherein said mode transformer is a transverse mode transformer.

20. The method of claim 10 wherein said mode transformer is a longitudinal mode transformer.
